(19) United States
(12) Patent Application Publication
(10) Pub. No.: US 2005/0252845 A1
(43) Pub. Date: Nov. 17, 2005

(54) Filter device with a segmented design

(76) Inventor: Werner Kemmelmeyer, Thansau (DE)

Correspondence Address: BACHMAN & LAPOINTE, P.C., 900 CHAPEL STREET, SUITE 1201, NEW HAVEN, CT, 06510, US

(21) Appl. No.: 10/511,361

(22) PCT Filed: Feb. 13, 2003
(86) PCT No.: PCT/DE03/00437

§ 371 Date: Jun. 6, 2005

(30) Foreign Application Priority Data
May 8, 2002 (DE) 102 20 644.9

(51) Int. Cl. B01D 29/50

(52) U.S. Cl. 210/323.1; 210/488; 210/497.01; 55/482

(57) ABSTRACT

A filter device comprising: filter elements with wall openings on their internal ring and filter elements with wall openings on their external ring the elements being alternately stacked; an external housing; an internal filter conduit, which is configured through the internal ring walls of the filter elements and is connected to filter elements in addition to a first fluid conduit via the internal ring wall openings; and an essentially annular filter material that is located between two respective filter elements. The front faces of the filter elements have essentially planar, peripheral external and internal sealing surfaces, which, when the filter elements rest one on top of the other, clamping filter material therebetween, lie above one another and are rough.

### BACKGROUND OF THE INVENTION

The invention pertains to a filter device with elements which are arranged in a row on top of one another and are mainly cylindrical in shape and which can be mainly flow-charged radially, alternatively from outside and inside; the device also has a ring-shaped filter material between two of these elements. Generic filter devices are described in the document EP 0152903 B1, reference to which publication is made in totality, in order to avoid repetitions.

Thereby a ring-shaped sheet-type filtering material is charged through with the fluid to be filtered coming out of the end-side openings of hollow-cylindrical flow-charging elements which are arranged on top of one another on a fluid line meant for fluid to be filtered and are connected to it, and passed on into hollow-cylindrical discharge elements through end-side openings and then forwarded out of these into a filtrate chamber. The elements should preferably be made of material having a long life span, like metal, especially steel or plastic and include between themselves respectively a filter material sheet that can be replaced after getting worn out.

Filter devices of this type have very high requirements/specifications. Apart from safely and completely fulfilling the required filtering performances, one should be able to ensure a reliable, trouble-free operation, as a failure of the filter device would not only lead to unusable products, but will also mean enormous losses due to standstill. Generic filter devices can be used in various carriers, e.g. for filtering out solid substances or even liquids from gases, e.g. for separating oil from compressed air (oil separator), for removing micro-organisms from beverages, from nutritive broth of fermenting agents and more similar items. Thereby these filter devices have to withstand temperatures up to 200, sometimes up to 300° C. and pressures in the range of 16 bar to 20 or even 30 bar. They should not fail if the designed capacity is exceeded by two times or even three times, sometimes even at short notice.

Particularly in production of groceries and beverages, like say in breweries, apart from the already addressed requirements, very often it also has to be ensured that the filtrates are sterile after passing through the filter. If this sterilisation effect fails, which cannot always be identified immediately, then large production quantities can be rendered unusable.

A problem with filtering plants according to the state-of-the-art technology lies in the sealing of the filter material gaskets against the charging and discharging elements. Till now, the filter material gaskets are held between the charging and discharging elements by a more or less plane sealing edge running all around inside and outside, whereby the elements get pressed on one another, in order to ensure a sealing through the thrust pressure. In a preferred design form, this stack of elements is pressed, one on top of the other, by a tie rod running through the centre axis of the filter, and the filter medium is sealed at the edge regions.

It has been seen in the case of known generic filter plants, that during assembly a twisting of the ring-type charging elements against each other is possible, and this could result in damage and in some cases even shearing off of the filter membranes. The holding of the filter membrane discs in the sealing region had in the past led to a channel formation in case of higher load and hence to leakage. This occurred particularly when in case of increased pressure the fluid could form a path in the soft membrane material. The tightness of the membrane vis-à-vis the elements therefore still left scope for improvement.

It is an object of the invention to provide a filter device wherein the sealing of the filter elements is improved.

### SUMMARY OF THE INVENTION

The object is achieved by the invention by means of a filter device with largely hollow cylinder-shaped filter elements stacked alternately above one another and having inner ring wall openings, and filter elements having outer ring wall openings; an outer housing which with the outer ring walls of the filter elements forms an outer housing fluid chamber, which ends in a second fluid pipeline; a filter inner pipeline which is formed by the inner ring walls of the filter elements and is connected to the filter elements as well as to a first fluid pipeline through the inner ring wall openings; between every two of these filter elements a mostly ring-shaped filter material is arranged, whereby the filter elements are largely hollow cylinder shaped and have an inner ring wall, an outer ring wall as well as an upper and lower end face with openings, whereby the filter elements have openings either on their radial outer wall or inner wall, whereby a fluid line can be created from the inner pipeline of the filter through the inner wall openings in the inner wall of the hollow cylinder-shaped filter elements and through the end-side openings of the same through the ring-shaped filter material and through the end-side openings into the next hollow cylinder shaped filter element having outer openings and through whose openings arranged in the outer walls, into the filtrate chamber or a housing chamber or, in case of reverse flow, a fluid line can be created from outside to the inner pipeline; a cover part for tight closing of the upper filter element; and a base part for locking the lowest filter element; whereby the end faces of the filter elements largely have flat peripheral outer and inner sealing surfaces which, because of the filter elements lying on top of one another, get to lie above one another on account of filter material get jammed in between, and become uneven.

As already explained, for a filter device of the type mentioned here, it is of great significance that it is completely sealed, i.e. it should be ruled out that the filtering fluid gets through the filter device without filtration, i.e. bypasses the filter material. For this it is very important that the filter material, especially in the case of a filter device as described further above is tightly held between the elements, i.e. between the respective outer and inner ring walls. This can basically be supported, in that the elements are surrounded at their outer and inner edge with a sealing skirting.

Due to the fact that now uneven or rough sealing surfaces are foreseen, any twisting of the elements against the filter material is avoided and hence any damage of the membranes due to the rotation movement is prevented. Furthermore, in this way a channel formation can be prevented, as in the sealing region different densities of the filter material exercise a slightly lower thrust pressure. Unevenness in this case means roughness that does not harm the intermediately lying membrane, but exercises an impression to the extent that a twisting of the membrane is avoided. Even the channel formation is prevented as the roughness tightens the membranes due to the impression.

It is therefore the principle of this invention that the filter material—with or without strainers—should be fastened torsion-free in the sealing ring, as in case of a rotation of the filter elements, e.g. on cooling of the tie rod, the membranes sometimes get damaged or even sheared off. The filter material—with or without support-strainers—is impressed according to the principle through the roughness of the sealing surfaces and then lies untwistable on the corresponding surface or the corresponding surrounding region. The element is also held similarly in untwistable on the membrane. Furthermore, one can obtain a desired elasticity a reliable sealing locking between the elements and the filter materials in between, as explained further details below.

Process-technically it is favourable, in case the unevenness of the outer and inner sealing surfaces are more or less same. As method for creating the unevenness of the sealing surfaces, one has the possibility of sand blasting, ball blasting, laser processing, milling or any other processing method known to the expert, for the material of the sealing edges. What is important is that the unevenness is not so high that it penetrates the filter material or seriously damages it; it must be created in such a way that only an impression of the sealing region of the membrane will take place, but no puncturing or cutting of the same. To a certain degree, the choice of roughness depends also on the filter material used; filter materials that disintegrate easily withstand lesser roughness than highly elastic, expandable materials with good tensile strength like PTFE or aramide.

Process-technically it is also meaningful to have the unevennesses of the outer and inner sealing surfaces by and large with the same roughness. For supporting the filter material and keeping away coarse impurities, it is advisable to connect at least one strainer before or after the filter material in flow direction. Production-technically it could be sensible to design the cylinder-shaped filter element in several parts, at least consisting of an inner ring and an outer ring as well as, if required, one or several strainers. It could also be advantageous if one strainer can be placed on the end face. It is preferable that the filter material is arranged at a distance to the strainer. In the flow direction at least one strainer can be connected either before or after the filter material—in this way, coarse impurities can be pre-filtered.

It can be favourable if the filter elements, the housing and the cover part and base part, are at least partly made of plastic. This gives the advantage of simple and cost-effective production. But for filters with particularly long life span or those subjected to high mechanical load, it can be advantageous if the filter elements, the housing and the cover part and base part are at least partly made of metal, like steel.

In a preferred design form, the cylinder-shaped elements are designed in several parts, having at least one inner ring and an outer ring (as well as, if required, one or several strainers). Thereby at least one strainer can be fitted into the outer ring wall and/or the inner ring wall. The filter material can be arranged at a distance from the strainer—however, it could also partly lie on it.

The ring-shaped filter material can be solely made of or in combination of ceramic, metal, natural or synthetic polymers, synthetic resin-ion exchanger, polymers of halogenated hydrocarbons, teflon, porcelain, glass, metal, paper, cellulose, felt, leather, asbestos, glass, sawdust, pumice stone, titanium dioxide, and, if required, also be made of two or several layers. On account of the filter material it could be necessary to design the filter membrane in such a way that it consists of different substances. Thus, for example, one may desire a sandwich-type structure or even an arrangement in which the filter membrane has a holding/supporting region which has a different composition than the filtering region. The ring-shaped filter material can in some cases of application, e.g. in case of ion exchange resins, be regeneratable. The filter material in its entire edge region works together with the elements to provide a sealing effect. Because of the principle of sealing the filter material in its entire edge region with or against the hollow cylinder-shaped elements, with the help of the uneven sealing surfaces, it is possible in the case of a generic filter device to avoid the above mentioned disadvantages. For pressure-sensitive filter materials, like glass sinters or other brittle materials it could be advantageous if the flat filter material has a holding/supporting region having a different composition than the filter region.

To ensure the thrust pressure on the element compound, which is important for the sealing tightness of the filter, it is preferable if in the inner pipeline a tie rod is foreseen, on which the hollow cylinder-shaped filter elements and the ring-shaped filter material are inserted and which is fixed in the upper cover cap and the lower cover cap and thus tightens the filter elements/filter material stack. This could be in the form of a long bolt and, if required, can be supported with a compression spring under tension. Providing a tie rod is however not important—one can resort to any other measure which ensures a pressure on one another of the filter elements stack while completely sealing the combination through pressing on one another of the sealing surfaces, as is well known to the expert.

If the filter elements do not reveal sufficient stability against the pressure which has to be applied on the elements, then it could be favourable if the cylinder-shaped elements have support walls running radially to the axis of the inner line and vertically to the end faces of the element.

The openings in at least one end face of the hollow cylinder-shaped elements, through which the filter material is then charged or the filtrated enters into the filter element, can be a hole type or slotted typed (see FIG. 8) and/or in the type of a strainer.

While mounting the filter—i.e. while placing the individual charging elements on top of one another and tightening the charging elements combination, the roughened surfaces of the sealing region of adjacent charging elements come to lie on the opposite sides of a filter material gasket which get locally compressed and tightened on account of the unevenness, so that any twisting of the filter material against the charging elements and any twisting of the charging elements against one another can be avoided.

Each filter element that works as charging lead element has at least one inflow opening and at least one discharge opening, which is designed in the inner wall or in the outer wall, as well as filter material accesses, out of which the “filter ”-medium flows into the filter device as per the invention, whereby the purified filtrate is then drawn off into the filtrate chamber of the filter device through the discharge openings.

In case of reverse charging direction—which can be done for “cleaning” the filter—the fluid to be filtered flows from outside to inside.

Here one must refer to the initially described flow direction with inner wall and designate the closing region of each filter element inwards, i.e. in case of the known double pipe structure, the region corresponding to the inner pipes. Similarly the region under the outer wall having a larger diameter than the pipes, has to be designated. The inflow opening of the outer wall or the discharge opening in the inner wall results in the fact that in each case a defined “chamber” is created, into which the filtrate once flows in from inside, is diverted and then passes through a filter gasket which is situated above or below it. Such a chamber, which could also have discharge openings or inflow openings distributed over the circumference, has roughened sealing surfaces or sealing strips above and below running around on the inside or outside, against which the elements can be pressed to produce a sealing effect.

In particular cases, e.g. if there are very highly stable membranes like ceramic membranes or highly stable plastic membranes (nylon, fluorated, hydrocarbons, aramides etc.) the filter material itself may be sufficient; a strainer or supporting element will not be necessary.

The element of a filter device as per the invention can basically be designed in one piece. Production-wise it is however advisable to manufacture the element in the form of an inner ring wall and outer ring wall which are connected to one another by strainers. The strainer can be welded or pasted on its inner and outer edge with the inner and outer edge. Particularly if a strainer is arranged before and after the filter material, it is advisable to connect the strainer to the inner ring wall and the outer ring wall in a detachable manner, perhaps by a screwing mechanism. One can also think of clamping or using clamp screws.

It is extremely important for sealing tightness of the filter device and the sealing combination of the elements with the filter material, that for all elements and on all inner ring walls and outer ring walls of the elements the necessary pressure between the adjacent elements always prevails, in order to ensure the sealing pressing of the filter material. Particularly if relatively thin filter material is used, which is also relatively less expandable, then the pressure between outer or inner ring walls of the elements can drop significantly due to occurrence of settlement.

For holding the elements together, generally the upper and lower holders of the elements are tightened against one another with a tie rod. The tie rod could be a long bolt guided through the centre of the filter device coinciding with the axis of the filter device.

A filter device as per the invention, as described above, can be basically operated with the filter material. As the flow-through capacity is also a function of the available filtering surface, it is advantageous to accommodate as many filter units as possible in a particular space. An economic utilisation of space can be achieved by relative elements. In order to fulfil this, the invention further advises that in filter devices of the type being discussed here, especially in a filter device with one or several features described above, to use plastic membranes as filter material. The starting material for such membranes is marketed, for example, also under the brand name GORE-TEX: Such a filter material consists of a membrane that is filter-active.

### BRIEF DESCRIPTION OF THE DRAWINGS

Advantageous extensions of the invention can be obtained from the sub-claims, as well as the subsequent description of the enclosed drawing showing only design examples. The following are shown:

FIG. 1 A partly sectioned view of a design example of a filter device as per the invention;

FIG. 2 principle diagram of the fluid course in a filter device as per the invention;

FIG. 3 a perspective view of the filter device shown in FIG. 1 with removed housing;

FIG. 4 two elements of the filter device as per the invention with a filter membrane lying in between, shown enlarged;

FIG. 5 an alternate design of an element as per the invention;

FIG. 6 an alternate element that is opened inwards and closed towards the outer pipe;

FIG. 7 a top view on an element as shown in FIG. 4 and FIG. 5 with support walls;

FIG. 8 a further alternative element with slit-type openings in the end faces, in top view;

FIG. 9 filter material in top view; and

FIG. 10 Schematic diagram of the charge flow of the filter material in a filter device between two filter elements.

### DETAILED DESCRIPTION

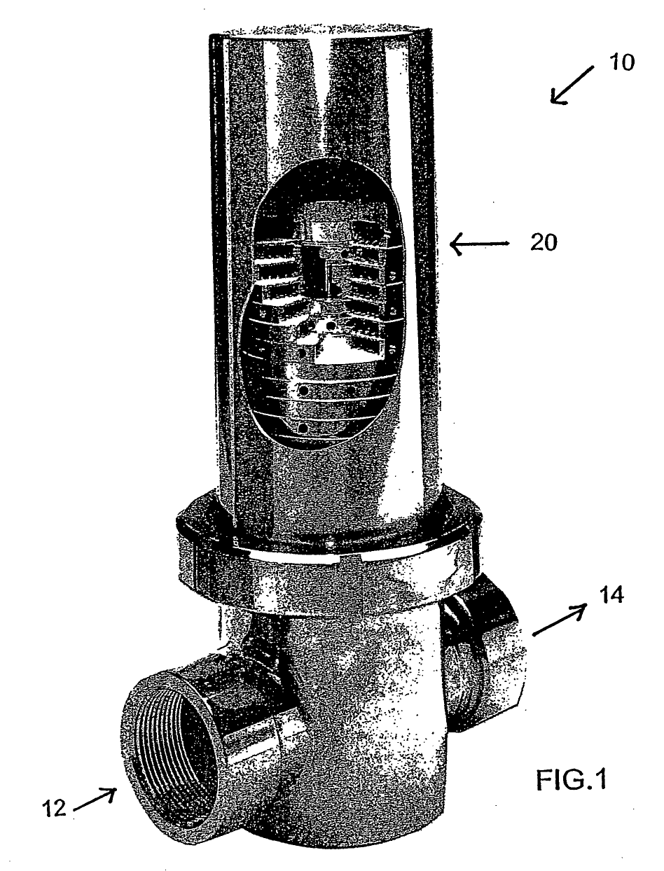

A filter device 10 for fluids has been shown and described, i.e. for filtering of gases, liquids or similar items in process-technical plants, as described in details above at the beginning. This filter device is particularly suited for gas filtration. An example of filters as per the invention, as shown in FIG. 1, are oil separators, water separators, ion exchangers and similar items.

FIG. 1 shows a perspective depiction of a preferred extension of a device as per the invention, whereby a window is cut in a housing 20. One can clearly identify the elements alternately lying above one another with strainer-type end faces 7 and alternately outer and inner openings which allow entry of fluid from the inner pipe 18 or the housing chamber 16 which is formed between the outer ring walls 9 and the housing 20.

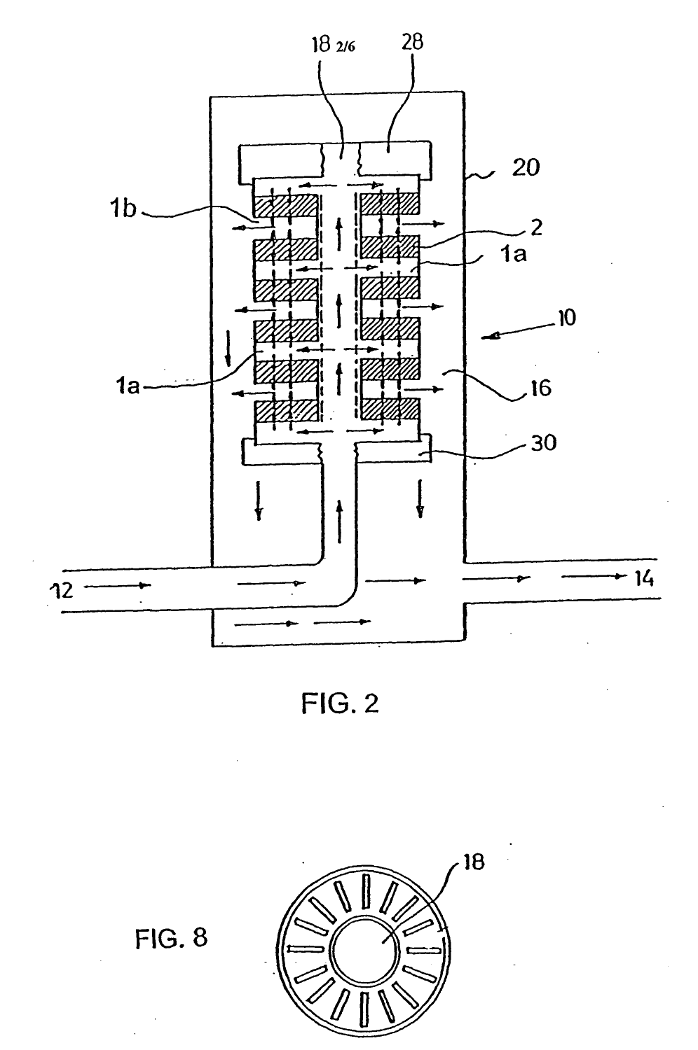

FIG. 2 gives the diagram of the fluid flow in the filter device 10, whereby here the inflow of the fluid to be filtered takes place through the inner pipeline 18 and the outflow of the filtered fluid takes place through the housing chamber 16. One can clearly identify that the fluid to be filtered reaches the filter device 10 through the inlet pipe 12, passes through the elements 1a through the inner wall openings 4, and is then filtered through the filter membrane 2 which is fixed tightly on the end wall 7 with openings, enters it through the end wall 7 of the next element 1b and then leaves it through the outer wall openings 3 in the housing chamber or the outer chamber 16 and is then guided out in a filtered condition through the second fluid pipe 14 which is connected here as discharge pipe. The filter device 10 shown in FIG. 2 is very much enlarged in order to show the filter material 2 clearly and is also depicted very thickly—this in no way corresponds to a technical realisation of the invention but is only meant for the purpose of better understanding. As one can see, the elements 1b are closed on the inside, i.e. towards the inflow pipe 12, and the elements 1a have an opening 4 towards the inflow pipe 12.

In the example shown in FIG. 2, the fluid to be filtered flows through the openings of the elements 1a open towards the inflow pipe 12, and then after diversion of the flow almost by 90° flows through the filter material 2 and then again after a flow diversion by about 90° through further elements 1b which are opened outwards, that is towards the filtrate chamber 16. The elements 1a, 1b are supported by upper and lower skirting or cover caps 28 or 30.

The fluid to be filtered flows from the first fluid pipe 12 into the respective filter elements 1a, or more precisely the inlet pipe 12 leads into a filter inner pipe 18 which can also be formed by the respective inner ring walls 8 of all filter elements 1a, 1b, that are either opened or not opened towards it.

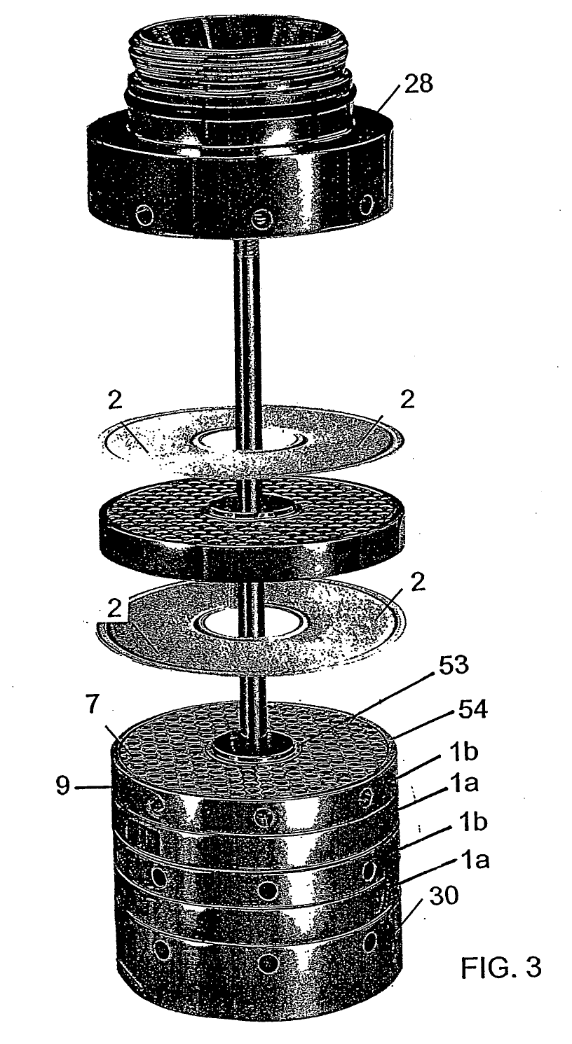

As shown more precisely in FIG. 3, which presents a perspective view of the inner filter region without housing 20, the filter device 10 is mainly made up of elements 1a, 1b, 11a, 11b, 22a, 22b, that is, mainly made up of circular ring-shaped elements which have an outer ring wall 9 and an inner ring wall 8 and end faces 7, i.e. respectively an element base and an element top with openings. In the design example shown in FIG. 2, the outer ring wall 9 and the inner ring wall 8 are held together by strainer element bases or tops 7, which are then respectively connected in a shape-hugging manner to the outer ring wall 9, as one can see in the drawing.

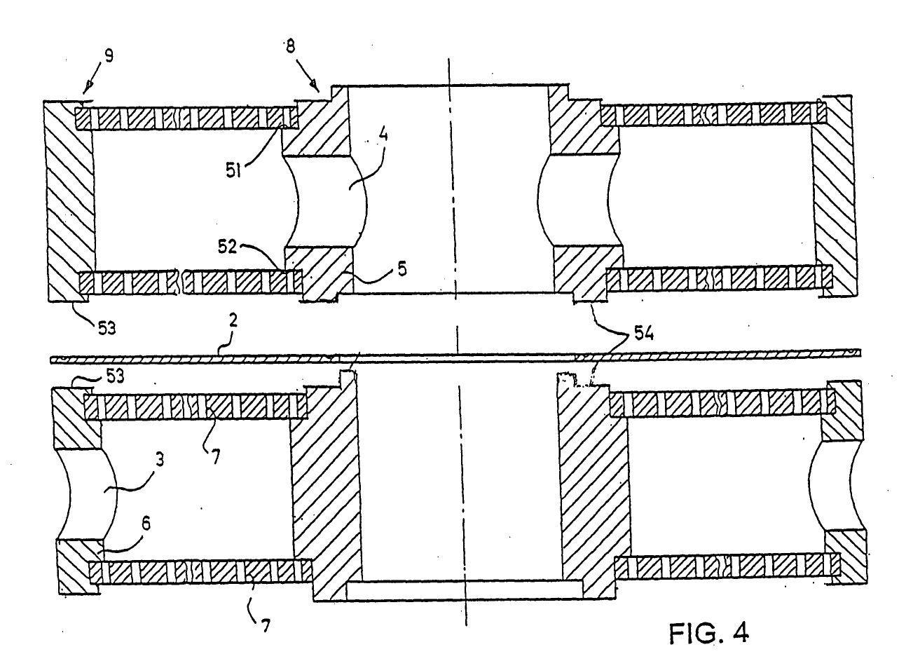

As further shown in FIG. 3 and also in FIG. 4, the inner ring wall openings 4 are designed as inflow openings and the outer ring wall openings 3 operated as outflow openings are designed in the outer ring wall 8 or the inner ring wall 9, as holes.

In FIG. 4 one can see that on the outer ring wall 9 and the inner ring wall 8 there are uneven support surfaces 53 or 54 running all around, on which the filter material 2 rests with its edge region right through. Thus the filter material 2 is held completely tight-sealed between two filter elements 1a, 1b which again have corresponding sand-blasted sealing surfaces 53 and 54 on their lower side.

In FIG. 4 one can see two outflow openings 3 or inflow openings 4; however, each filter element can have either more or lesser outflow openings or inflow openings.

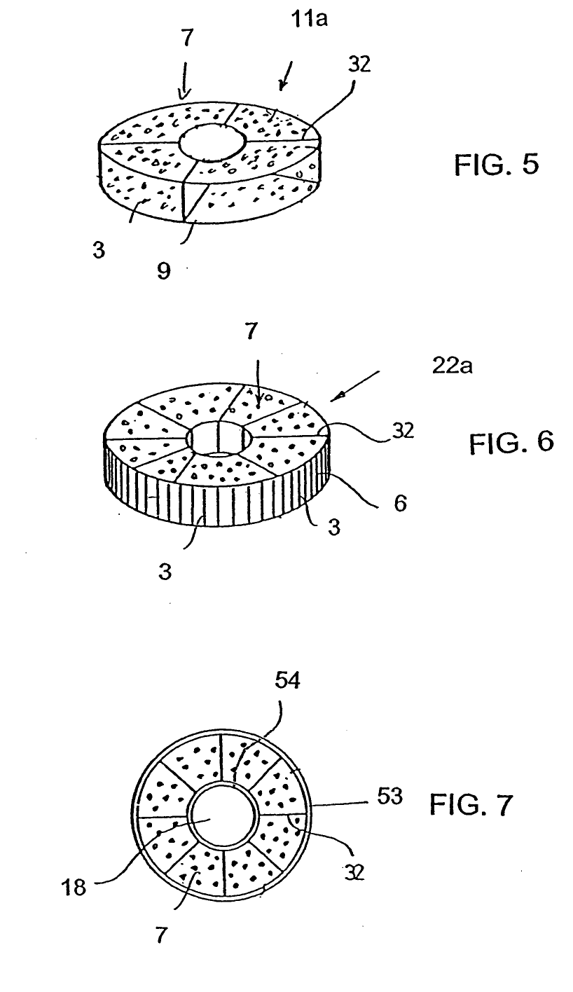

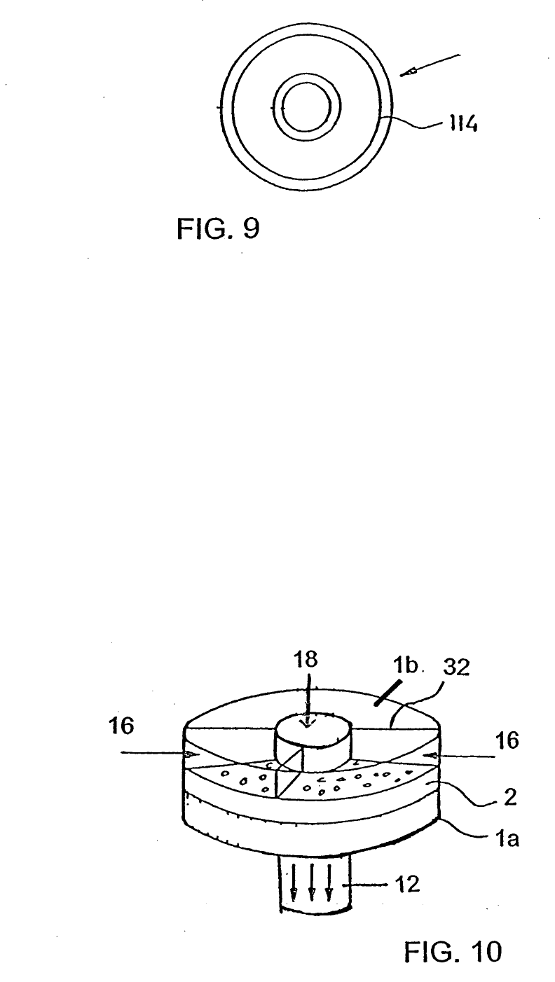

FIGS. 3 and 9 show a design form of a filter membrane 2, which often finds application as filter material 2 as per the invention. This filter membrane here is a PTFE-membrane and consists of one layer. As one can see in the perspective diagram shown in FIG. 3, the filter material 2 or the filter membrane reveal recesses in the edge region, whose advantages have already been described above. In the FIGS. 5 to 7 alternative design forms of the elements are shown. As one can see from the above description, for a filter device 10 as per the invention it is necessary to have different elements 1a, 1b or 11a, 11b or 22a, 22b working together.

The filter element 11a shown in FIG. 5 is provided with openings 3 into the housing chamber 16, which could have any shape that would be conducive with the stability of the filter element. Here they are designed as holes. These openings 3 allow a free exit of the filtrate that flows out of the filter material 2 into the filter element 11b open outwards, through the openings in the end face 7 of the filter element 1a. The filter elements receive the fluid to be filtered, which is not yet purified and guide it through the openings in their end faces 7 into the filter material 2. As the filter elements 11a are constantly subjected to impurities in this flow direction, it may be necessary to clean the elements 11a separately, or even to replace them or to make them of a material that is insensitive to impurities. The filter elements 11b which are opened outward and which in this flow direction come in contact with the filtered fluid, would not required cleaning so frequently and could be made of any cost-effective material which is not so resistant. Thereby, in order to absorb pressure exercised on the filter elements it would be advisable to provide radial/star-shaped support walls 32 in the individual elements 11a, 11b, 1a, 1b, 22a, 22b, which will prevent any distortion of the filter elements in the direction of the filter main axis, which again might lead to leakages in the arrangement. The number of radial support walls 32 is not very critical; due to reasons of increased mechanical load, provision of support walls 32 can be particularly advantageous in case of heavily weakened supporting ring walls 8, 9, as shown in FIG. 6.

FIG. 5 shows a further preferred design form of the openings in the ring wall surface of the filter elements 22b as radial slots, which would be desirable due to reasons of material and resistance. Of course, even circular openings or any other suitable form of openings can be foreseen in the end faces 7 of the filter elements 1a, 1b, 11a, 11b, 22a, 22b, whereby the size and shape of the openings have restrictions only with respect to stability of the filter elements.

As shown in FIG. 8, it is also possible to design the openings in the end faces 7 as slots.

A sealing of the filter material 2 against the inner pipeline and outer pipeline is necessary. This is done, in that the filter material sheet 2 is strongly compressed and held by the pressure of the filter elements in the edge region and sealing region by the roughened sealing surfaces 53, 54 in such a way, that any flow-through of fluid is not possible.

FIG. 10 shows in details the use of the filter membrane 2 as per the invention under a charging filter element 1b with support walls. To simplify the diagram, the upper end face of the charging filter element has been left out. The fluid to be filtered enters here—shown clearly by the arrows—through open side walls of the filter element gasket 1b out of the housing chamber 16, then through the strainer-type perforation into the lower end face 7 of the element 1b, the element base, into the filter material sheet 2 lying below it, leaves the filter material in a filtered condition and runs into a end face 7 provided with openings, into a structurally similar filter element 1a, which is open towards the filter inner pipeline 18 and closed towards the housing chamber 16, then to the filter inner pipeline 18 and from there into the filter fluid pipeline 12. The lower filter element is here shown in the diagram as end element and therefore does not have any openings on its base. Such filter arrangements can be stacked on top of one another at any heights, whereby for achieving a satisfactory filtration, the sealing of the filter materials against the filter element sealing surfaces is very important, in order that no impure fluid can bypass the membranes 2.

The features of the invention indicated in the above description, the drawing and the claims can be important individually as well as in any random combination for realizing the invention in its various extensions.

1-16. (canceled)

17. A filter device comprising
first filter elements and second filter elements which are substantially hollow cylindrical in shape having inner ring walls defining an inner pipeline and outer ring walls, the first and second filter elements being alternately stacked one above another, the first filter elements having openings in the inner ring walls communicating with the inner pipeline and the second filter elements having openings in the outer ring walls;
an outer housing spaced from the outer ring walls an defining therewith an outer fluid chamber, wherein the openings in the outer walls of the second filter elements communicate with the outer fluid chamber;
an inlet fluid pipeline communicating with the inner pipeline and an outlet fluid pipeline communicating with the outer fluid chamber;
a substantially hollow ring shaped filter material positioned between the alternating first and second filter elements, wherein the first and second filter elements each have upper and lower end faces with openings, wherein the filter material is held between the faces such that there is a flow direction from the inlet pipeline to the inner pipeline, through the inner ring wall openings and the ring shaped filter material, through the outer ring wall opening to the outer fluid chamber and the outlet fluid pipeline;
upper and lower cover parts for sealing the filter elements together with the filter material; and
the end faces of the filter elements each have an inner ring sealing surface and an outer ring sealing surface for sealing the ring shaped filter material therebetween.

18. A filter device according to claim 17, wherein at least one of the inner and outer ring sealing surfaces of a filter element comprises first and second offset surfaces which mate with corresponding first and second offset surfaces in an adjacent filter element.

19. A filter device according to claim 18, wherein the first and second offset surfaces are located on the inner ring sealing surface.

20. A filter device according to claim 18, wherein the outer ring sealing surfaces and inner ring sealing surface have the same roughness.

21. A filter device according to claim 17, wherein the filter elements, the housing, the cover part and base part are made at least partly made of plastic.

22. A filter device according to claim 17, wherein the filter elements, the housing, the cover part and base part are made at least partly of metal.

23. A filter device according to claim 17, wherein at least one strainer is located at at least one of before and after the filter material in the flow direction.

24. A filter device according to claim 17, wherein at least one strainer is located on the end faces of the filter elements.

25. A filter device according to claim 24, wherein the filter material is located a distance from the strainer.

26. A filter device according to claim 17, wherein a tie rod is provided in the inner pipeline on which the hollow cylindrical filter elements and the ring-shaped filter material are inserted, wherein the tie rod is fixed in the upper cover part and the lower cover part.

27. A filter device according to claim 17, wherein the filter elements have support walls running radial to an axis of the inner pipeline and vertically to the end faces of the filter elements.

28. A filter device according to claim 17, wherein the filter material has a holding region which has a different composition than a filtering region.

29. A filter device according to claim 28, wherein the filter material has an edge region which is roughened.

30. A filter device according to claim 28, wherein the filter material comprises a material selected from the group consisting of ceramic, metal, natural or synthetic polymers, synthetic resin-ion exchangers, polymers of halogenated hydrocarbons, teflon, porcelain, glass, metal, paper, cellulose, felt, leather, asbestos, glass, sawdust, pumice stone, titanium dioxide and mixtures thereof.
